(19) United States
(12) Patent Application Publication
(10) Pub. No.: US 2026/0008056 A1
(43) Pub. Date: Jan. 8, 2026

(54) DEVICES, SYSTEMS, AND METHODS FOR SPECIMEN COLLECTION

(71) Applicant: PAVmed, Inc., New York, NY (US)

(72) Inventors: Michael Boutillette, Sudbury, MA (US); Amos G. Cruz, Franklin, MA (US); Emily Hommel, Santa Clara, CA (US); Sydney LaPlant, Foxborough, MA (US); Deborah Leszczynski, Boston, MA (US); Elizabeth Ling, Walpole, MA (US); Stephen O'Neill, Boston, MA (US); Brian deGuzman, Paradise Valley, AZ (US)

(21) Appl. No.: 19/119,388

(22) PCT Filed: Oct. 31, 2023
(86) PCT No.: PCT/US2023/036416

§ 371 Date: Apr. 8, 2025

Related U.S. Application Data
(60) Provisional application No. 63/381,892, filed on Nov. 1, 2022.

(51) Int. Cl. B01L 3/00

(52) U.S. Cl. CPC B01L 3/50825; B01L 2200/0689; B01L 2200/141; B01L 2300/042; B01L 2300/046; B01L 2300/0627

(57) ABSTRACT

In some examples, a specimen collection system includes a receptacle having a wall, an inner-area defined by the wall, and an opening configured to provide access to the inner-area, an inner cap having an external surface, an interior surface, an aperture through the external and interior surfaces, and a cutting mechanism, the inner cap configured to releasably couple with the receptacle and align the aperture with the opening when coupled to the receptacle, and an outer cap having an internal surface, the outer cap, when in a closed position, configured to cover the external surface and place a section of a specimen collector in an extended state.

### CROSS REFERENCE TO RELATED APPLICATION

The present application claims the benefit of priority to U.S. Provisional Application No. 63/381,892, filed Nov. 1, 2022, and titled “Devices, Systems and Methods for Specimen Collection.”

### FIELD OF THE DISCLOSURE

The present disclosure relates to devices, systems, and methods for specimen collection. More particularly, the present disclosure relates to a receptacle lid for use in systems and methods for collecting specimen samples.

### BACKGROUND

Testing biological materials is a critical part of modern healthcare and life science research. Such materials include the cells, tissue, and biofluids of the subject at interest. Whether the materials are used for monitoring, prognosis, diagnosis, or research, the collection of such materials must be conducted free of contamination and in sufficient quantities to complete the intended tests. Typically, a test is run multiple times using various portions of the same sample to ensure the results are reliable.

Biological samples are collected in numerous ways. Some are collected via a procedure that utilizes a specimen collector best suited for collecting the specific type of material or for collecting the material from a specific area of the subject. For example, narrow-handled swabs are used for collecting biofluids from nasal passages, while balloon-tipped catheters are used for collecting cells from a human's esophagus. Typically, before biological materials are tested, they must be transported to a testing facility and/or delivered to testing personnel. In order to protect the collected biological material from contamination, at least a portion of the specimen collector carrying or containing biological materials are traditionally deposited in a vial or container immediately after the collection procedure is complete. Specimen collectors are often too large to deposit their entirety in a container and only the portion of the collector carrying or containing the material is needed for testing. Accordingly, the portion of the collector carrying the biological material is often cut away from the rest of the specimen collector before being deposited into a vial or container. However, scissors, scalpels, or other cutting devices inherently present contamination risks since the portion of the collector that is deposited touches the cutting device which may not have been properly sanitized or may have become contaminated after being sanitized.

### SUMMARY

There is a need for improvements to specimen collection devices, particularly those susceptible to contamination and insufficient sample extraction. The present disclosure is directed towards solutions to address this need, in addition to having other desirable characteristics. Specifically, the present disclosure provides a receptacle lid that can be implemented as part of specimen collection systems to provide reduced risk of contamination and improved collection rates.

In accordance with some embodiments, a receptacle lid is provided. The lid includes an inner cap, a cutting mechanism, and an outer cap. The inner cap has an external surface, an interior surface, and an aperture through the interior and external surfaces. The outer cap has an internal surface, is configured to cover a portion of the external surface and, when moved from an open position to a closed position, place a section of a specimen collector in an extended state.

In accordance with some embodiments, a specimen collection system is provided. The system includes a receptacle that has a wall, an inner-area defined (at least in part) by the wall, and an opening configured to provide access to the inner-area. The system also includes an inner cap, a cutting mechanism, and an outer cap. The inner cap has an external surface, an interior surface, and an aperture through the interior and external surfaces. The inner cap is configured to releasably couple with the receptacle and align the aperture with the opening of the receptacle when the inner cap is coupled to the receptacle. The outer cap has an internal surface, is configured to cover at least a portion of the external surface of the inner cap and, when moved from an open position to a closed position, place a section of a specimen collector in an extended state.

In accordance with some embodiments, a method for collecting a specimen is provided. The method includes providing a receptacle lid configured to releasably couple with a receptacle, where the receptacle lid includes an inner cap, a cutting mechanism, and an outer cap. The inner cap has an external surface, an interior surface, and an aperture configured to permit a specimen collector to pass through the inner cap. The cutting mechanism is configured to cut a specimen collector. The outer cap has an internal surface and is configured to cover at least a portion of the inner cap's external surface and, when moved from an open position to a closed position, place a section of the specimen collector in an extended state. The method also includes receiving the section of the specimen collector contained within the receptacle sealed by the receptacle lid.

### BRIEF DESCRIPTION OF THE FIGURES

These and other characteristics of the present disclosure will be more fully understood by reference to the following detailed description in conjunction with the attached drawings, in which:

FIG. 1 illustrates an exemplary receptacle lid having an inner cap and outer cap, in accordance with some embodiments of the present disclosure;

FIG. 2 illustrates an exemplary specimen collection system, in accordance with some embodiments of the present disclosure;

FIG. 3A illustrates an exemplary prospective inner cap, in accordance with some embodiments of the present disclosure;

FIG. 3B is an exemplary side view of an inner cap, in accordance with some embodiments of the present disclosure;

FIG. 3C is an exemplary cross-sectional side view of the inner cap of FIG. 3B, in accordance with some embodiments of the present disclosure;

FIG. 4A illustrates an exemplary outer cap, in accordance with some embodiments of the present disclosure;

FIG. 4B is an exemplary cross-sectional side view of an outer cap, in accordance with some embodiments of the present disclosure;

FIG. 5A is an exemplary cross-sectional side view of the receptacle lid of FIG. 1 in an open position, in accordance with some embodiments of the present disclosure;

FIG. 5B is an exemplary cross-sectional side view of the receptacle lid of FIG. 1 in a closed position, in accordance with some embodiments of the present disclosure;

FIGS. 6A illustrates an exemplary receptacle, in accordance with some embodiments of the present disclosure;

FIG. 6B is an exemplary cross-sectional side view of the receptacle of FIG. 6A, in accordance with some embodiments of the present disclosure;

FIG. 7A is an exemplary cross-sectional side view of the specimen collection system of FIG. 2 in an open position, in accordance with some embodiments of the present disclosure;

FIG. 7B is an exemplary cross-sectional side view of the specimen collection system of FIG. 2 in a closed position, in accordance with some embodiments of the present disclosure;

FIG. 8A is a cross-sectional side view of an exemplary specimen collector in a compact state;

FIG. 8B is a cross-sectional side view of the exemplary specimen collector of FIG. 8B in a protruded state;

FIG. 8C is a cross-sectional side view of the exemplary specimen collector of FIGS. 8A-8B in an extended state;

FIG. 8D illustrates an exemplary cross-sectional side view of a specimen collection system in an open position in use with an exemplary specimen collector in a compact state inserted partially through the inner cap of the specimen collection system, in accordance with some embodiments of the present disclosure;

FIG. 8E illustrates an exemplary cross-sectional side view of the specimen collection system of FIG. 8D in further use with an exemplary specimen collector having been cut, while inserted partially through the inner cap of the specimen collection system, by the cutting mechanism of the specimen collection system, in accordance with some embodiments of the present disclosure;

FIG. 8F illustrates an exemplary cross-sectional side view of the specimen collection system of FIGS. 8D-8E in further use having been moved to a partially closed position with an exemplary specimen collector inserted partially through the inner cap of the specimen collection system, cut by the cutting mechanism of the specimen collection system, and in a protruded state, in accordance with some embodiments of the present disclosure; and

FIG. 8G illustrates an exemplary cross-sectional side view of the specimen collection system of FIGS. 8D-8F in further use having been moved to a closed position with an exemplary specimen collector inserted partially through the inner cap of the specimen collection system, cut by the cutting mechanism of the specimen collection system, and in an extended state, in accordance with some embodiments of the present disclosure.

### DETAILED DESCRIPTION

An illustrative embodiment of the present disclosure relates to a receptacle lid for use in specimen collection systems and methods. The receptacle lid is configured to provide an inner cap, an outer cap and a cutting mechanism. The outer cap is configured to cover the inner cap. The inner cap includes an aperture. The cutting mechanism and aperture are configured for a specimen collector to be inserted through the aperture and cut by the cutting mechanism such that contamination sources are reduced. For example, typically scissors or other cutting tools are used to cut sample collectors in order to deposit a portion of the sample collector into a receptacle. Such cutting devices must be properly sterilized prior to use in order to avoid contamination of the sample. The cutting mechanism removes the possibility of improperly sterilized cutting tools being used to cut the specimen collectors, thereby preventing contamination of the sample.

In a further embodiment, the outer cap is configured to cause a specimen collector to protrude, extend and/or expand, such that specimen collection rates are increased for certain specimen collectors. For example, some embodiments are configured to increase gas pressure in an area between the outer cap and the inner cap, and/or decrease gas pressure within an inner-area of the receptacle, such that the resulting pressure differential changes the state of a specimen collector. One such specimen collector is a catheter-balloon assembly that includes a balloon connected to a catheter, where the balloon is in an extended state and inflated when used to collect a sample on the external surface of the inflated balloon. Typically, such specimen collectors are in a collapsed and/or deflated state when added to a receptacle, after which a solution in the receptacle extracts the specimen from the external surface of the collapsed and/or deflated balloon. Causing a pressure differential between an area defined by the caps and the inner-area of the receptacle while those areas are sealed and the balloon is within the receptacle, such as by increasing gas pressure within an area between the caps and/or reducing gas pressure within the receptacle, extends, expands and/or inflates the balloon thereby increasing the balloon's external surface area and exposing more of the balloon's external surface, and thus more of the specimen, to the solution such that collection rates are increased.

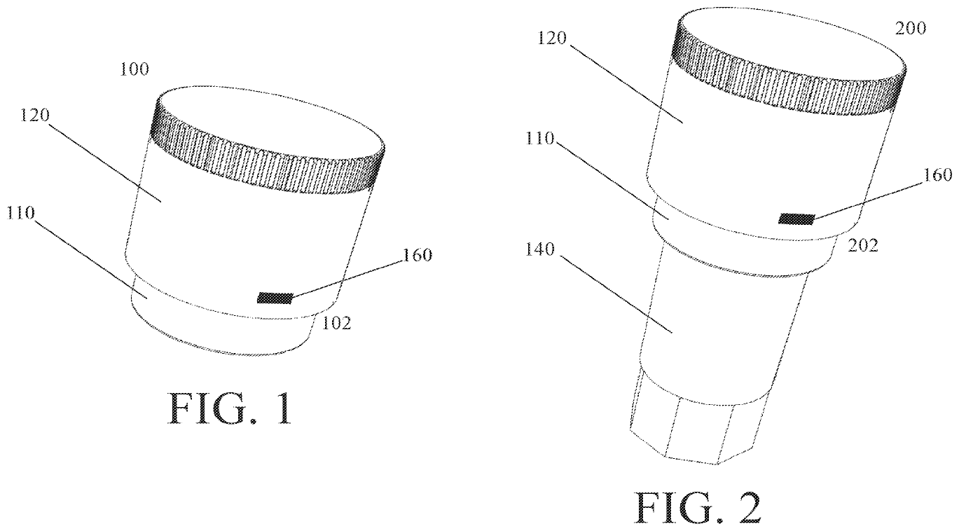

FIGS. 1 through 8G, wherein like parts are designated by like reference numerals throughout, illustrate exemplary embodiments of improved devices, systems, and methods of use, for specimen collection according to the present disclosure. Although the present disclosure will be described with reference to the exemplary embodiments illustrated in the figures, it should be understood that many alternative forms can embody the present disclosure. One of skill in the art will additionally appreciate different ways to alter the parameters of the embodiment(s) disclosed, such as the size, shape, or type of elements or materials, in a manner still in keeping with the spirit and scope of the present disclosure.

Referring to FIGS. 1, and 3A-5B, an exemplary embodiment of a receptacle lid is depicted. The receptacle lid 100 includes an inner cap 110, an outer cap 120, and a cutting mechanism 130. In certain embodiments the cutting mechanism 130 forms part of or is attached to the inner cap 110. The inner cap 110 includes a body 111 that has an external surface 111a, and interior surface 111b, and an aperture 112 through the body 111. The outer cap 120 includes a body 121 that has an exterior surface 121a and internal surface 121b. The outer cap 120 may be configured to move from an open position 10 to a closed position 20 in which it covers at least a portion of the external surface 111a of the inner cap 110.

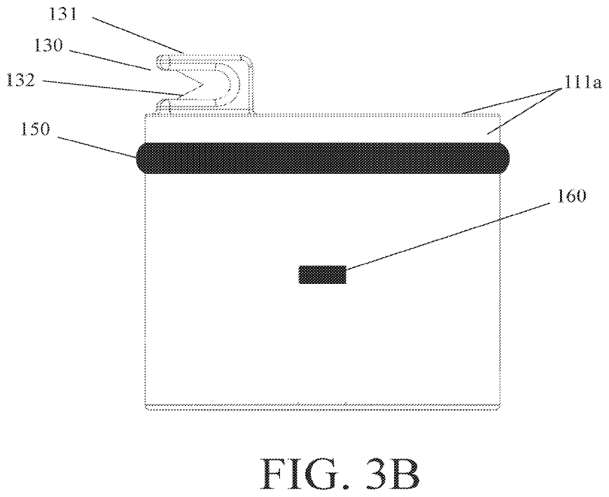

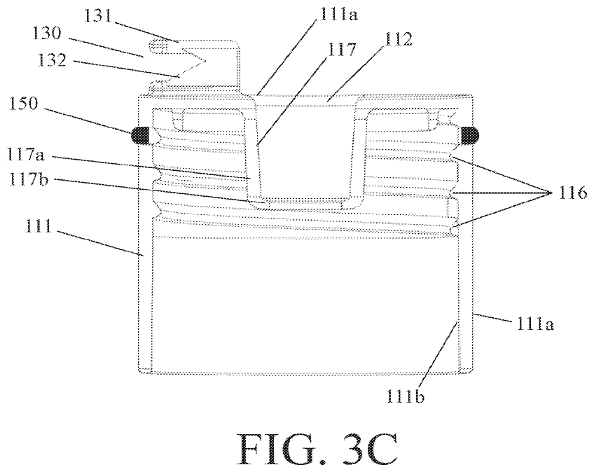

Cutting mechanism 130 is configured to cut a specimen collector. Cutting mechanisms include blades, wires, pincers, heating elements, compression elements, pressure elements, and/or similar. In certain embodiments, the cutting mechanism 130 may include a body 131 and a blade 132. In some embodiments, cutting mechanism 130 is detached and/or separate from the inner and outer caps (110, 120), while configured to interact with one or both of the inner cap 110 and outer cap 120. In other embodiments, cutting mechanism 130 is attached to and/or forms part of the inner cap 110 and/or the outer cap 120. For example, in the embodiments of FIGS. 3A-3C the body 131 of the cutting mechanism 130 protrudes from the external surface 111a of the inner cap 110 and retains the blade 132 in proximity to the inner cap's aperture 112, while in other embodiments the cutting mechanism includes one or more components attached to the outer cap and one or more components attached to the inner cap that are configured to jointly cut a specimen collector (e.g., two blades, a blade and a backing, etc.).

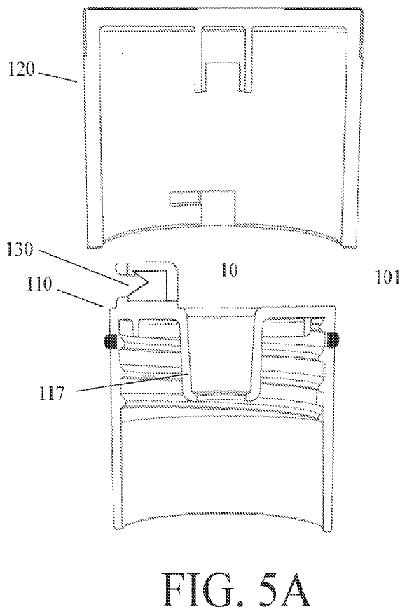

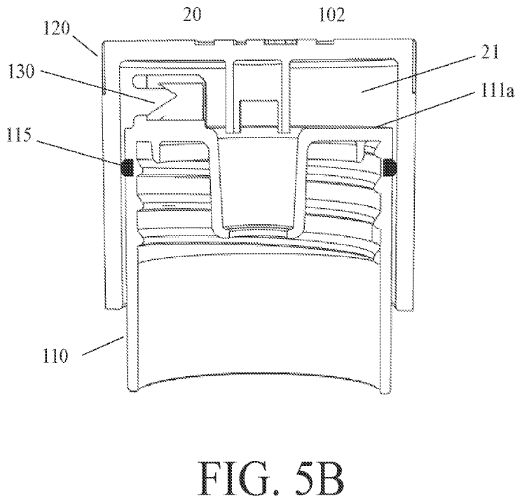

The receptacle lid 100 may include a sealing mechanism 150. In certain embodiments the sealing mechanism 150 forms part of or is attached to the inner cap 110 (FIGS. 3B, 3C). In some embodiments the sealing mechanism forms part of or is attached to the outer cap 120. The sealing mechanism 150 may be configured to seal (fully or partially) the area 21 between the inner cap 110 and the outer cap 120 when the receptacle lid 100 is moved from an open configuration 101 (FIG. 5A) to a closed configuration 102 (FIG. 5B). Sealing mechanisms may include gaskets, pliable washers, interlocking structures, tapered body sections, springs, packings, threads, O-rings, or similar sealing components. For example, the sealing mechanism 150 may include an O-ring sized and shaped to enable gas pressure within area 21, between the internal surface 121a of the outer cap 120 and the external surface 111a of the inner cap 110, to increase as the outer cap 120 is moved from an open position 10 (FIG. 5A) to a closed position 20 (FIG. 5B).

The receptacle lid 100 may include one or more retaining mechanisms 117. configured to receive a portion of a sample collector while the receptacle lid is in an open configuration 101. A retaining mechanism may be sized and/or shaped to hold a portion of a sample collector. A retaining mechanism may define the furthest point of insertion for at least a portion of a sample collector. In certain embodiments, a retaining mechanism 117 is attached to and/or forms part of the inner cap 110. In some embodiments a retaining mechanism is an extension of the aperture 112. For example, in the embodiment shown at FIG. 3C, the inner cap 110 includes a retaining mechanism 117 that includes a well or depression aligned with the aperture 112. A retaining mechanism may include one or more tapered walls 117a and/or a lip 117b.

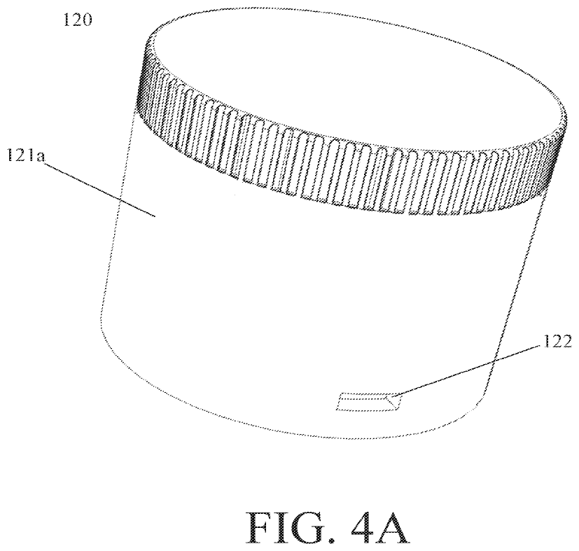

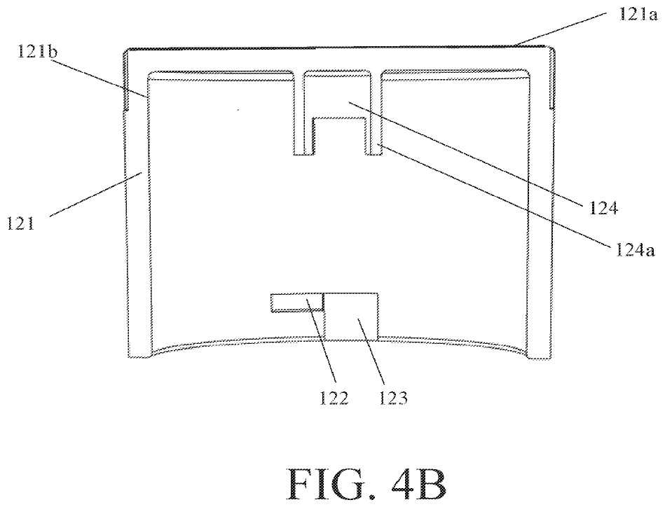

The receptacle lid 100 may include one or more securing mechanisms 124 configured to secure at least a portion of a sample collector while the receptacle lid is in a closed configuration 102. A securing mechanism may be sized/shaped to restrict movement of a portion of a sample collector. In certain embodiments, a securing mechanism 124 may be part of the outer cap 120. For example, in the embodiment shown at FIGS. 4B and 5B, the outer cap 120 may have a securing mechanism 124 that includes one or more extensions 124a connected to the inner surface of the outer cap.

The receptacle lid 100 may include one or more connection mechanisms, such as cap-connection mechanisms and/or receptacle-connection mechanisms. Connection mechanisms may include screw threads, protrusions, depressions, cut-outs, seals, latches, or similar.

Cap-connection mechanisms may be configured for coupling the inner cap and outer cap. Cap-connection mechanisms may be configured to interact and/or pair with one or more other cap-connection mechanisms. Cap-connection mechanisms may be attached to or form part of the inner cap 110 and/or the outer cap 120. The inner cap 110 may include one or more cap-connection mechanisms configured for coupling the inner cap 110 with the outer cap 120, and/or the outer cap 120 may include one or more cap-connection mechanisms configured for coupling the outer cap 120 with the inner cap 110. For example, in the embodiment shown at FIGS. 1 and 3A-5B, inner cap 100 may include a protrusion-type cap-connection mechanism 114 on the external surface 111a, which pairs with a cut-out 122 and depression 123 of the outer cap 120 to form a press-and-twist bayonet style cap-connection configured to couple the inner cap 110 with the outer cap 120 and keep the outer cap 120 in the closed position 20.

Receptacle-connection mechanisms may be configured for coupling the inner cap and receptacle. Receptacle-connection mechanisms may be configured to interact and/or pair with one or more other receptacle-connection mechanisms. Receptacle-connection mechanisms may be attached to or form part of the inner cap 110 and/or a receptacle 140. The inner cap 110 may include one or more receptacle-connection mechanisms configured for coupling the inner cap 110 with the receptacle 140, and/or the receptacle 140 may include one or more receptacle-connection mechanisms configured for coupling the receptacle 140 with the inner cap 110. For example, as seen in FIG. 3C, inner cap 110 may include one or more screw threads 116 on interior surface 111b which pair with one or more screw threads 144 on the outer surface 141 of the receptacle 140 to form a thread style receptacle-connection configured to couple the inner cap 110 with the receptacle 140.

The receptacle lid 100 may include one or more pressurization mechanisms configured to increase gas pressure in area 21 between the inner cap 110 and the outer cap 120. Pressurization mechanism may include, but are not limited to, mechanical pumps, electrical pumps, check valves, release valves, tubing, seals, or similar. The outer cap 120 may include one or more pressurization mechanisms, and/or the inner cap 110 may include one or more pressurization mechanisms. For example, the outer cap may include a check valve and a mechanical pump, such as a push-diaphragm, at least partially exposed on its exterior surface, such that the pump may be utilized by a user to increase the pressure within area 21 once the outer cap/receptacle lid/collection system is in a position with area 21 sealed.

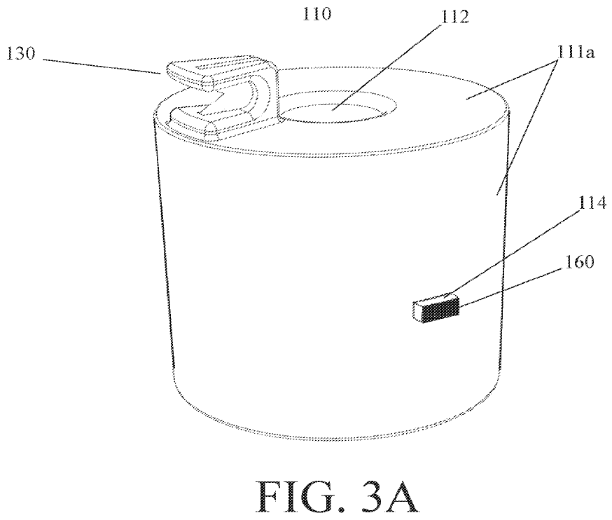

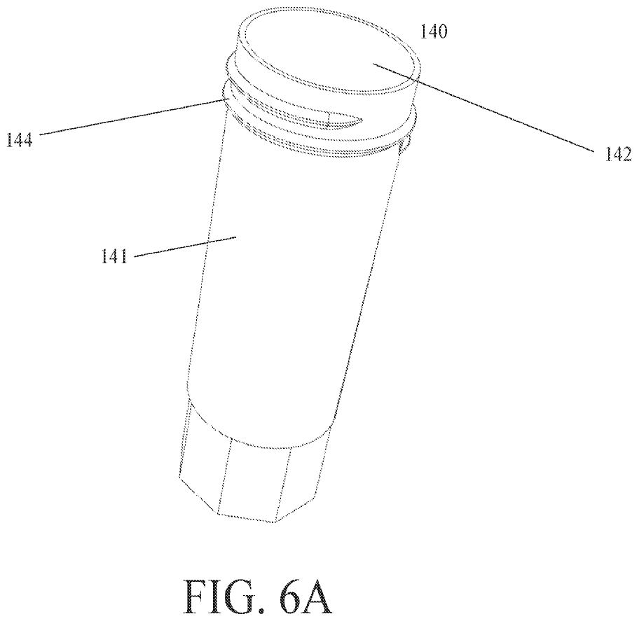

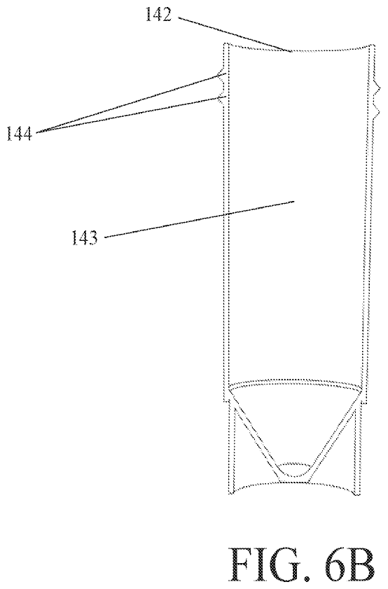

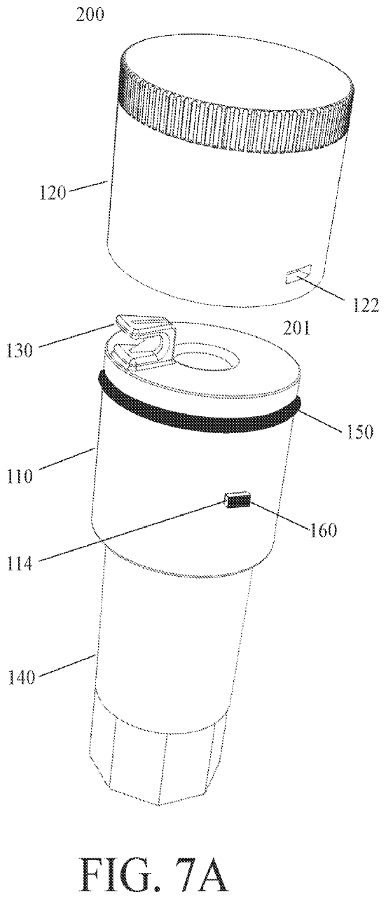

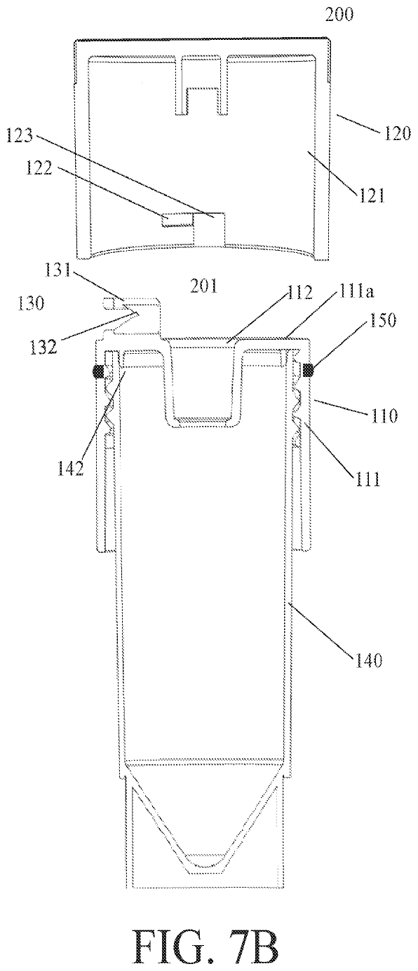

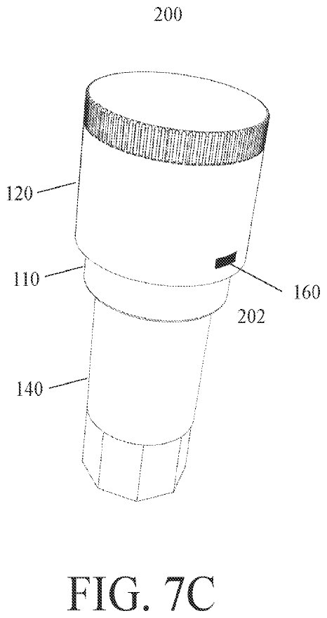

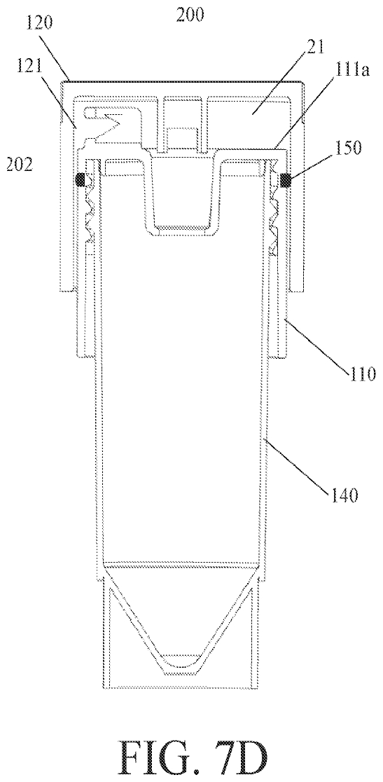

Referring to FIGS. 2, and 6A through 7D, an exemplary embodiment of a specimen collection system 200 is described. In some embodiments, a specimen collection system includes a receptacle lid and a compatible receptacle. In certain embodiments, such as the embodiment at FIGS. 7A-7B, a specimen collection system 200 includes a receptacle 140, an inner cap 110, an outer cap 120, and a cutting mechanism 130. The receptacle 140 includes a wall 141, an inner-area 143 defined by the wall 141, and an opening 142 (e.g., FIGS. 6A and 6B). The inner cap 110 includes a body 111, which has an external surface 111a, and an aperture 112 through the body 111. The outer cap 120 includes a body 121, which has an internal surface 121b. The inner cap 110 is configured to releasably couple with the receptacle 140 and align the aperture 112 with the opening 142 when coupled to the receptacle 140. The system 200 is configured to be moved from an open position 201 (FIGS. 7A, 7B) to a closed position 202 (FIGS. 7C, 7D) in which the outer cap's internal surface 121b covers at least a portion of the inner cap's external surface 111a.

In certain embodiments at least a piece of the specimen collection system's cutting mechanism 130 forms part of or is attached to the inner cap 110. For example, in the embodiment at FIGS. 7A, 7B, and 7D the body 131 of the cutting mechanism 130 is attached to, and forms part of, the inner cap's external surface 111a and retains a blade 132 in proximity to the inner cap's aperture 112. The outer cap may include at least a piece of the specimen collection system's cutting mechanism, such as, for example, a blade and/or body. In some embodiments, the cutting mechanism may be configured to move, such as, for example, rotate, slide, and/or close, in relation to the inner cap and/or outer cap.

In some embodiments the cutting mechanism is detached and/or separate from the inner and outer caps. For example, in certain embodiments, the cutting mechanism may be configured to fit within a slot/aperture through the body of the inner or outer cap, such that the cutting mechanism may be inserted through the slot/aperture to cut the specimen collector. In some embodiments, the cutting mechanism may be an intermediate cap that is configured to be placed over the at least a portion of the inner cap and/or specimen collector. For example, the cutting mechanism may be configured to sit on top of the inner cap and/or between the inner and outer caps.

The specimen collection system 200 may include one or more specimen sensors configured to inform the user that the amount of specimen within the receptacle is sufficient for the intended uses. Specimen sensors may include, but are not limited to, electrical circuitry, electrodes, transducers, batteries, displays such as, lights, light-emitting-diodes, liquid crystals, color changing materials, or similar. For example, the receptacle may include a specimen sensor having a display on the outer surface of the receptacle and electrical circuitry extending from the display to the inner-area 143 of the receptacle, with the specimen sensor configured to change the appearance of the display in response to the electrical circuitry being in contact with the solution within the receptacle when the electrical resistivity of the solution sufficiently increases or decreases due to the amount of specimen extracted from the specimen collector by the solution.

In some embodiments, the specimen collection system 200 includes an indicator configured to inform the user that the specimen collection system is in a closed position. In some embodiments an indicator may be detached and/or separate from the inner cap 110 and/or the outer cap 120. For example, the collection system 200 may include a transparent section or window to allow the user to view one or more components, or a section of a specimen collector, that informs the user the system is closed. In certain embodiments, an indicator may be attached to and/or form part of the inner cap 110 and/or the outer cap 120. For example, in the embodiment of FIGS. 7A-7D, the inner cap 110 includes an indicator 160 on a surface of a protrusion-type cap-connection mechanism 114. When the specimen collection system 200 is moved from the open position 201 (FIGS. 7A, 7B), the indicator 160 becomes visible to the user once the system 200 is in the closed positions 202 (FIGS. 7C).

The specimen collection system 200 may include a sealing mechanism. In certain embodiments a sealing mechanism 115 forms part of or is attached to the inner cap 110 (FIGS. 7A, 7B). In some embodiments a sealing mechanism forms part of or is attached to the outer cap 120. In some embodiments a sealing mechanism forms part of or is attached to the receptacle 140. A sealing mechanism 115 may be configured to (fully or partially) seal the area 21 between the inner cap 110 and the outer cap 120, and may be configured to do so as the specimen collection system 200 is moved from an open position 201 (FIG. 7A) to a closed position 202 (FIG. 7B). A sealing mechanism may be configured to (fully or partially) seal the inner-area 143 of the receptacle 140.

In some embodiments, the specimen collection system may include a specimen collector. In some embodiments, at least a portion of a specimen collector is configured to fit through the aperture of the inner cap. In some embodiments, the specimen collector includes a specimen collection section and an extension section. In some embodiments, the collection section is configured to gather specimen on an external surface of the collection section. In some embodiments, at least a portion and/or section of a specimen collector is configured to have various states, such as for example, a packed state, a protruded state, and/or an extended state. In some embodiments, at least a portion and/or section of a specimen collector is configured to retract and/or collapse to a packed state. In some embodiments, at least a portion and/or section of a specimen collector is configured to move, such as, for example, elongate, inflate, extend, and/or expand, to a protruded state and/or an extended state.

As would be appreciated by one skilled in the art, FIGS. 1-8G are for exemplary purposes only and the outer cap 110, the inner cap 120, the cutting mechanism 130, the receptacle 140, and the sealing mechanism 150 may include any combination of shapes and sizes to form any combination of sized and shaped receptacle lids and specimen collection systems, and the receptacle lid 100, the specimen collection system 200, as well as the components thereof, may be constructed from any combination of materials using any combination of methods known in the art, depending of the desired application.

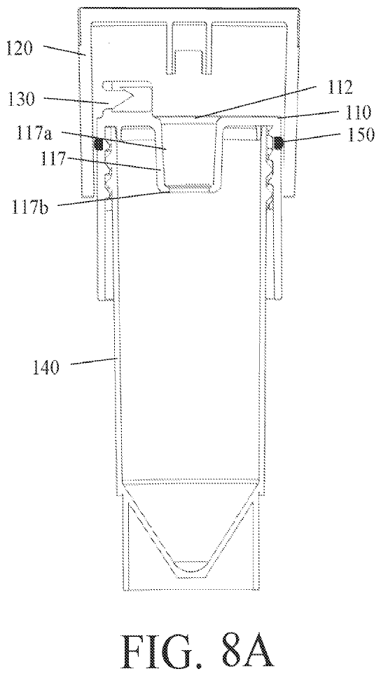

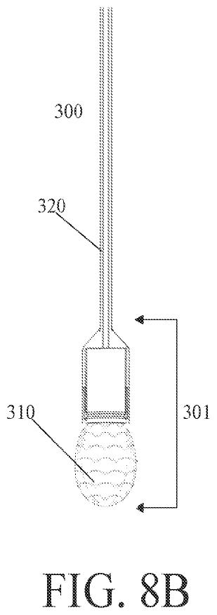

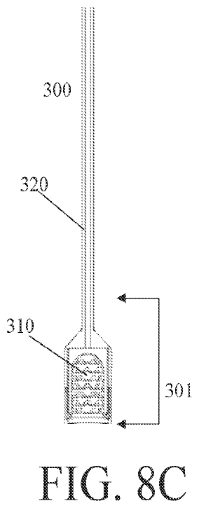

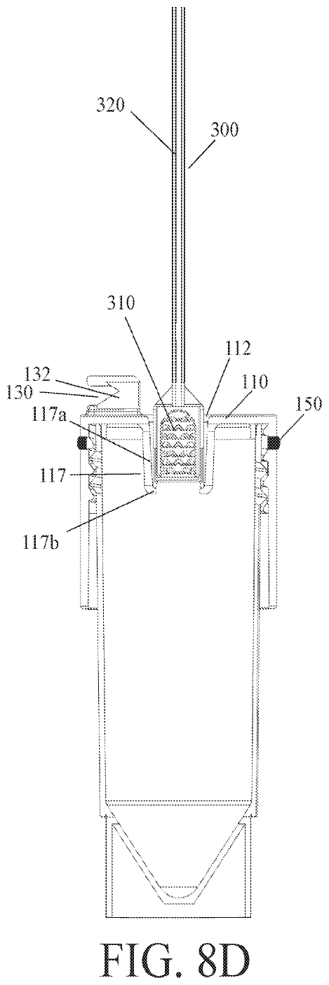

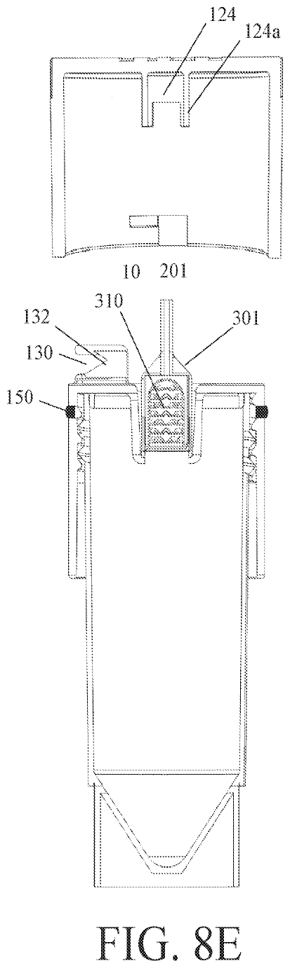

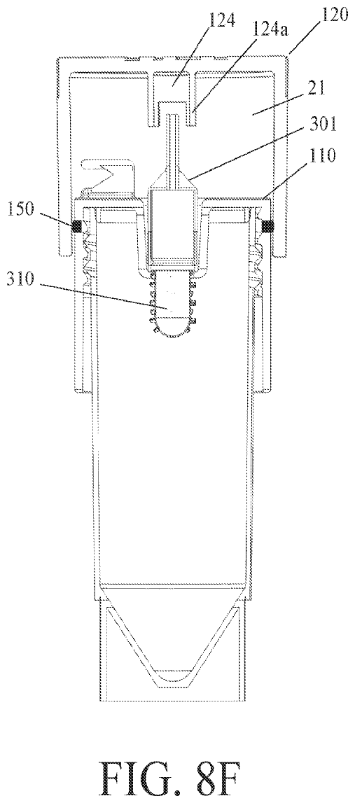

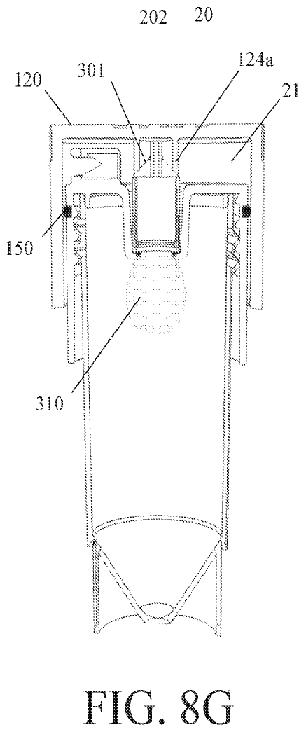

With reference to FIGS. 8A-8F, use of an exemplary embodiment is described below. In some embodiments, a receptacle lid, having an inner cap 110, an outer cap 120 and a cutting mechanism 130 is provided to a user. In certain embodiments, a receptacle 140 is also provided such that a specimen collection system 200 is provided, while in other embodiments the user selects and/or supplies a compatible receptacle. In some embodiments, a receptacle lid or specimen collection system is utilized once a user has gathered specimen with a specimen collector 300 (FIG. 8B), which includes a specimen collection section 301 and an extension section 302. In certain embodiments, specimen are gathered on an external surface of the collection section 301. Some specimen collectors retract and/or collapse after specimen have been gathered, such that the specimen collection section 301 is in a packed state with specimen carried on the collection section 301. For example, as seen in FIGS. 8B-8G, certain embodiments of the present disclosure are compatible with a specimen collector 300 that is a catheter-balloon assembly. Such specimen collectors' extension sections 320 include a catheter, and the collection sections 310 include a balloon that is expandable via gas and/or liquid being driven into the lumen of the catheter and into the inner cavity of the balloon. Certain embodiments of the present disclosure are configured to place the collection section 310 in an extended state by causing a pressure differential between the gas pressure in area 21 and gas pressure within inner-area 143. For example, some embodiments are configured to increase gas pressure in area 21 while the area 21 is sealed, such as, for example, by moving the outer cap 120 from an open position 10 to a closed position 20. The pressurized gas flows into the inner cavity of the collection section via the catheter due to the configuration of the receptacle lid or specimen collection system.

With gathered specimen on the specimen collector 300, at least part of the specimen collector 300 is inserted through aperture 112 of the inner cap 110. In certain embodiments, upon insertion a retaining mechanism 117 holds at least a portion of the specimen collector 300. For example, in the embodiment shown at FIG. 8D the inner cap 110 has a retaining mechanism 117, which includes a tapering conical wall 117a, aligned with the aperture 112 and configured to hold, at least part of, specimen collector 300. In certain embodiments the furthest point of insertion for specimen collector 300 is defined by a retaining mechanism 117. For example, in the embodiment shown at FIGS. 8D-8G the retaining mechanism 117 includes tapering walls 117a that narrow and contact the specimen collector 300 as it is inserted through the aperture 112, and includes a lip 117b that, alone or in combination with the tapering walls 117a, prevent the specimen collector 300 from being further inserted.

With the specimen collector 300 inserted, at least partially, through the aperture 112 of inner cap 110, the cutting mechanism 130 is used to cut the specimen collector 300 such that a portion 301 of the specimen collector 300 remains inserted. For example, as shown at FIG. 8D to 8E, the extension section 320 is cut by blade 132 to at least shorten the length of the specimen collector 300 and leave portion 301, at least part of which is carrying the gathered specimen, held by the tapering conical wall 117a.

With the specimen collector 300 inserted, at least partially, through the aperture 112 and cut by the cutting mechanism 130 to leave portion 301, the collection system/receptacle lid/outer cap (200/100/120) is moved from an open position (201/101/10) to a closed position (202/102/20). Moving the system/receptacle lid/outer cap from an open position to a closed position increases sample collection rates and/or reduces the likelihood of contamination when certain specimen collectors are utilized.

For example, collection sections 310 are typically in an extended state (FIG. 8B) when specimen are gathered on the external surface of the collection section 310. For certain specimen collectors, the collection section 310 collapses and/or retracts to a packed state (FIG. 8C) once specimen are gathered on the collection section 310. If a sample is extracted while the collection section 310 is in the packed state (FIG. 8C), the amount of gathered specimen available for extraction is inherently reduced due to the packed state inherently reducing the amount of the collection section's surface area that is exposed. Typically, to extract a specimen while the collection section 310 is in an extended state, lab technicians or medical personnel must manually cause the collection section 310 to transition from the packed state to the extended state, which inherently increases the likelihood of contamination and/or human error. Conversely, certain embodiments of the present disclosure are configured to place the collection section 310 in the extended state as the system/receptacle lid/outer cap closes, and before a specimen sample is extracted. As a result, the surface area of the collection section increases and results in the extraction of larger samples without either of the collection section or specimen being exposed to the contamination risks of contact or mishandling by a lab technician/medical personnel.

Sealing mechanisms 150 may be included to assist in causing the collection section 310 to extend and/or expand. For example, as seen in the embodiment of FIGS. 8D-8G, a sealing mechanism 150 on the external surface 111a of the inner cap 110 contacts the internal surface 121 of the outer cap 120 as it moves from an open position 10 to a closed position such that it seals, at least partially, the area 21 between the outer cap 120 and the inner cap 110. As shown in the embodiment from FIG. 8E to 8G, collection section 310 is in a compact state (e.g., retracted and/or deflated) while the portion 301 of the specimen collection 300 is inserted and outer cap 120 is in an open position 10 (FIG. 8E). Collection section 310 then moves to a protruded state (e.g., at least partially extended and/or partially inflated) when outer cap 120 is partially closed (FIG. 8F) as a result of the movement of outer cap 120 increasing gas pressure within area 21 while sealing mechanism 150 prevents the increased pressure from escaping area 21. Collection section 310 then moves to an extended state (e.g., substantially extended and/or substantially inflated) when outer cap 120 is moved further to closed position 20 (FIG. 8G), which further increases gas pressure within area 21 while sealing mechanism 150 continues to prevent the pressure from dissipating.

With the outer cap 120 in the closed position, and the collection section 310 in an extended state, a solution within receptacle 140 then extracts the specimen from the collection section 310. Due to the surface area of the collection section 310 being greater when collection section 310 is extended and/or inflated (FIG. 8G), the solution extracts a greater specimen sample than if the collection section 310 was in a packed and/or collapsed state (FIG. 8C). The specimen collection system (or the receptacle lid with a user supplied receptacle), which is in a closed configuration 202 and containing the collection section 310, is then delivered to and received by a specimen sample testing facility and/or specimen sample testing personnel.

In some embodiments outer cap 120 may include one or more securing mechanisms 124 configured to secure a portion 301 of a sample collector 300 while the outer cap 120 is in a closed position 20. A securing mechanism may be sized/shaped to restrict movement of a portion of a sample collector. In certain embodiments, a securing mechanism 124 forms part of the outer cap 120. For example, in the embodiments shown at FIGS. 8E-8G the outer cap 120 includes a securing mechanism 124 that has one or more extensions 124a connected to the inner surface 121 of the outer cap 120. As the outer cap 120 is moved from an open position 10 (FIG. 8E) to a closed position 20 (FIG. 8G), the securing mechanism 124 contacts the portion 301 of the sample collector 300 and prevents the portion 301 from moving while the outer cap 120 is in the closed position. In some embodiments, the securing mechanism 124 secures the position of portion 310 such that it seals, at least partially, the area 21 between the outer cap 120 and the inner cap 110, and/or seals, at least partially, the inner-area 143 of the receptacle 140. For example, in the embodiment shown at FIG. 8C, when in the closed position 20/configuration 202, securing mechanism 124a keeps portion 310 pressed against retaining mechanism 117 such that it seals, at least substantially, the aperture 112.

The outer cap 120 may include one or more cap-connection mechanisms 122, 123 configured to keep the outer cap 120 in the closed position 20. For example, in the embodiment at FIG. 8E outer cap 120 may include a cut-out 122 on the interior surface 121 and/or a depression 123 on the interior surface 121. The inner cap 110 may include one or more cap-connection mechanisms configured to match with the outer cap's cap-connection mechanisms 122, 123. The inner cap 110 may include one or more receptacle-connection mechanisms 116 configured for coupling the inner cap 110 with a receptacle 140. A receptacle 140 may include one or more receptacle-connection mechanisms 144 configured to pair with the inner cap's receptacle-connection mechanisms 116. For example, as seen in FIG. 3C, inner cap 110 may include screw threads 116 on its internal surface 111b configured to pair with screw threads 144 on the exterior of the receptacle 140 and keep the receptacle 140 coupled with the inner cap 110.

Some embodiments are configured to create the pressure differential between the gas pressure in area 21 and gas pressure within inner-area 143 by decreasing the gas pressure within inner-area 143. For example, in some embodiments the receptacle is configured to decrease the gas pressure within inner-area 143 by enlarging the volume of inner-area 143 once it has been sealed. For example, in certain embodiments the receptacle may include a moveable portion that at least partially defines the volume of inner-area 143 and may include an expansion mechanism configured to change the position of the moveable portion such that the volume of the inner-area 143 increases as the moveable portion changes positions thereby decreasing the gas pressure within the receptacle. Expansion mechanisms may include, but are not limited to, sliders, seals, threading, flexible membranes, pull tabs, or similar. Some embodiments include a vacuum mechanism configured to decrease gas pressure within the inner-area 143. Vacuum mechanisms may include, but are not limited to, mechanical pumps, electrical pumps, check valves, release valves, tubing, seals, or similar. For example, certain embodiments of a specimen collection system may include a mechanical pump and a check valve configured to decrease gas pressure within the inner-area 143 of the receptacle once a specimen collector has been inserted and the inner-area 143 has been sealed.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the disclosure. It is intended that the present disclosure be limited only to the extent required by the appended claims and the applicable rules of law.

It is also to be understood that the following claims are to cover all generic and specific features of the disclosure described herein, and all statements of the scope of the disclosure which, as a matter of language, might be said to fall therebetween.

What is claimed is:

1. A receptacle lid comprising:
an inner cap having an external surface, an interior surface, and an aperture through the external and interior surfaces;
a cutting mechanism; and
an outer cap having an internal surface, the outer cap configured to cover at least a part of the external surface and, when moved from an open position to a closed position, place a section of a specimen collector in an extended state.

2. The receptacle lid of claim 1 further comprising a sealing mechanism.

3. The receptacle lid of claim 2, wherein the sealing mechanism is attached to the inner cap.

4. The receptacle lid of claim 2, wherein the sealing mechanism includes an O-ring.

5. The receptacle lid of claim 1, wherein the cutting mechanism includes a blade and a body.

6. The receptacle lid of claim 1, wherein the cutting mechanism is attached to the external surface of the inner cap.

7. The receptacle lid of claim 1, wherein the cutting mechanism is configured to cut a specimen collector.

8. The receptacle lid of claim 1, wherein the aperture is configured to permit a specimen collector to pass through the inner cap.

9. The receptacle lid of claim 1, wherein the inner cap includes a retaining mechanism configured to hold a specimen collector.

10. The receptacle lid of claim 1, further comprising an indicator configured to indicate a position of the receptacle lid.

11. A specimen collection system comprising:
a receptacle having a wall, an inner-area defined by the wall, and an opening configured to provide access to the inner-area;
an inner cap having an external surface, an interior surface, and an aperture through the external and interior surfaces, the inner cap configured to releasably couple with the receptacle and align the aperture with the opening when coupled to the receptacle;
a cutting mechanism; and
an outer cap having an internal surface, the outer cap configured to cover at least a portion of the external surface and, when moved from an open position to a closed position, place a section of a specimen collector in an extended state.

12. The specimen collection system of claim 11 further comprising a sealing mechanism.

13. The specimen collection system of claim 11, wherein the cutting mechanism includes a body and a blade.

14. The specimen collection system of claim 11, further comprising a specimen sensor configured to indicate a sufficient amount of specimen is within the receptacle.

15. The specimen collection system of claim 11, further comprising an indicator configured to indicate a position of the specimen collection system.

16. A method for collecting a specimen, the method comprising the steps of:
providing a receptacle lid configured to releasably couple with and seal a receptacle, the receptacle lid comprising:
an inner cap having an external surface, an interior surface, and an aperture configured to permit a specimen collector to pass through the inner cap;
a cutting mechanism configured to cut the specimen collector; and
an outer cap having an internal surface, the outer cap configured to cover at least a portion of the external surface and, when moved from an open position to a closed position, place a section of the specimen collector in an extended state; and
receiving the section of the specimen collector contained within a receptacle sealed by the receptacle lid.

17. The method of claim 16, further comprising:
providing the receptacle, the receptacle having a wall, an inner-area defined by the wall, and an opening configured to provide access to the inner-area.

18. The method of claim 16, further comprising:
providing a solution configured for extracting a specimen sample from the section of the specimen collector.

19. The method of claim 16, further comprising:
providing a specimen collector having a specimen collection section, the specimen collector configured to:
gather biological material on a surface of the specimen collection section;
insert through the aperture;
be cut by the cutting mechanism, and
extend as the receptacle lid is moved from the open position to the closed position.

20. The method of claim 16, wherein the receptacle lid further comprises an indicator configured to indicate a position of the receptacle lid.
